(19) United States
(12) Patent Application Publication
(10) Pub. No.: US 2020/0171612 A1
(43) Pub. Date: Jun. 4, 2020

(54) APPARATUS AND METHOD FOR TRANSPORTING AND PROCESSING SEMI-FINISHED PRODUCTS

(71) Applicant: Maximilian SETTERL, Pfofeld (DE)

(72) Inventor: Maximilian SETTERL, Pfofeld (DE)

(21) Appl. No.: 16/608,136

(22) PCT Filed: Mar. 28, 2018
(86) PCT No.: PCT/EP2018/025073

§ 371 Date: Oct. 24, 2019

(30) Foreign Application Priority Data
Apr. 27, 2017 (DE) 102017004318.3

(51) Int. Cl. B23Q 5/22; B65G 15/24; B65G 13/00

(52) U.S. Cl. CPC B23Q 5/22; B65G 13/00; B65G 15/24

(57) ABSTRACT

An apparatus (1) for transporting and processing semi-finished products includes at least one processing unit (3), which has two support assemblies (4, 5, 23, 24) arranged one behind the other in the conveying direction (F) of the semi-finished product, a guide unit (6) and at least one processing head (7) arranged on the guide unit (6). A working region (A) of the processing head (7) extends between two support assemblies (4, 5, 23, 24) arranged one behind the other over a total width of the support assembly (4, 5, 23, 24). Each support assembly (4, 5, 23, 24) has two support segments (8, 9, 10, 11, 25, 26, 27, 28). At least one support segment (8, 9, 10, 11, 25, 26, 27, 28) is movable, such that the working region (A) of the processing head (7) is variable in the conveying direction (F).

The invention relates to a device for transporting and processing semi-finished products according to the preamble of claim 1 and to a method for transporting and processing semi-finished products by means of such a device.

In DE 10 2004 034 256 B4, a device for cutting sheet metal is disclosed. The device comprises at least one laser cutting device received in a frame as well as a device for receiving a metal sheet located in the cutting region of the laser beam. The device for receiving the metal sheet comprises a first conveying device and a downstream second conveying device in the transport direction with a gap forming an opening. Each conveying device comprises a carriage as well as four deflection rollers, wherein two deflection rollers are stationarily attached and the other two deflection rollers are movable relative to the stationary deflection rollers. A circumferential conveyor belt is guided circumferentially around these four deflection rollers. Moreover, a setting device is provided, by means of which the opening can be adjusted relative to the frame of the device and moved along in alignment with the laser beam.

In DE 102 35 903 A1, a method and a device for cutting shaped blanks made of sheet metal by means of a cutting beam are disclosed. The cutting device is arranged so that it can be pivoted by a drive above the moved sheet metal strip. The sheet metal strip is moved here continuously in a direction by multiple conveyor belts. For optimal support, the conveyor belts are implemented in different lengths.

In the published document EP 2 420 344 B1, a method and a device for producing a contour cut in a strip of sheet metal are disclosed. The device comprises at least three overlapping processing strips extending in the transport direction, with each of which a laser cutting device with a fixed working area is arranged. In view of the transport direction, two processing strips are arranged next to one another and one processing strip is arranged in the center behind the other two processing strips.

The aim of the present invention is to develop a maintenance-friendly and further developed device for transporting and processing semi-finished products, by means of which semi-finished products can be processed more efficiently.

To achieve the aim according to the invention, the device indicated in claim 1 and the method indicated in claim 9 are proposed. Optional advantageous designs of the invention result entirely or partially from the dependent claims.

The device according to the invention for transporting and processing semi-finished products, in particular a strip of sheet metal, comprises at least one processing unit which comprises two support groups arranged one after the other in the conveyance direction of the semi-finished product, a guide unit as well as at least one processing head arranged on the guide unit, wherein a working area of the processing head extends between two support groups arranged one after the other over the entire width of the support group. The device according to the invention is characterized in that each support group is constructed from two support segments, wherein at least one support segment of a support group can be moved, so that the working area of the processing head is variable in the conveyance direction. The working area of the processing head is preferably arranged between two movable support segments of two support groups lying one after the other in the conveyance direction.

The support groups can be formed, for example, as passive or as active support groups. Active support groups are understood to be driven support groups. Passive support groups, on the other hand, are understood to be non-driven support groups. As support groups, it is possible to use, for example, conveyor belts with drive, conveyor belts without drive, brush supports, roller blocks with drive or roller blocks without drive. Here, in each case, the type of the support segments used also preferably corresponds to the type of the support group. This means that, when a brush support is used, preferably all the support elements of the processing unit are formed as a brush support.

A brush support is understood to mean a support on which multiple brush bundles are applied, which extend perpendicularly to the conveyance direction of the semi-finished product. By using brush supports, semi-finished products with sensitive surfaces can be processed. An exemplary brush support is represented in WO 2007/134629 A1.

Roller blocks are understood to mean a support on which multiple rollers, arranged one after the other starting from the conveyance direction of the processing unit, are formed. The semi-finished products to be processed are transported via the rollers. An exemplary embodiment of the roller block is described in DE 90 07 082 U1.

As an example, the support group is formed as a conveyor belt group, wherein each conveyor belt group is constructed from two conveyor belt segments. Here, preferably each conveyor belt segment has at least one circumferential conveyor belt. This means that each conveyor belt segment forms a self-enclosed unit. In an additional exemplary embodiment of the device according to the invention, the support group is formed as a brush support group, wherein each brush support group is constructed from two brush support segments.

Furthermore, in an additional exemplary embodiment of the device according to the invention, the support group is formed as a roller block group, wherein each roller block group is constructed from two roller block segments.

The support segments, in particular conveyor belt segments, brush support segments or roller block segments, and thus also the support groups, in particular conveyor belt groups, brush support groups, roller block groups, are oriented with respect to one another in such a manner that the working area is sufficiently large to process the semi-finished product with the processing head and at the same time sufficiently small so that the support segments ensure a sufficiently large support for the semi-finished product.

A guide unit is understood to mean any unit which enables receiving at least one processing head, such as, for example, a bridge, a robot or a cantilever. The guide unit here is movable at least in longitudinal direction of the support, in particular a conveyor belt, brush support or roller block, that is to say it is movable in or against the conveyance direction. Width of the support group, in particular a conveyor belt group, brush support group, roller block group, is understood to mean the dimension of the support group transverse to the conveyance direction.

Variable support segments, in particular conveyor belt segments, brush support segments or roller block segments, are controlled preferably by at least one setting unit. This means that the setting unit sets the working area(s). In case of multiple processing units connected one after the other, multiple setting units can be used. The working areas move along with the part to be processed due to the movement of the movable support segments, in particular conveyor belt segments, brush support segments or roller block segments, of the processing unit. Thus, during the processing of the semi-finished product, the semi-finished product can be transported further, whereby a continuous processing and at the same time a continuous transporting of the semi-finished product are enabled. Alternatively to a processing during the transporting of the semi-finished product, the processing can also occur when the semi-finished product is stationary.

It is advantageous if the support segments of a support group, in particular conveyor belt segments of a conveyor belt group, brush support segments of a brush support group or roller block segments of a roller block group, are oriented with respect to one another in such a manner that the two support segments transport, support or carry the semi-finished product. This means that, preferably, each support segment is used as a support for the semi-finished product, and thus the support segments of a support group lie in a plane. Here, it is advantageous if the two support segments of a support group are arranged offset transversely to the conveyance direction.

In a preferred embodiment, the support segments, in particular conveyor belt segments, brush support segments or roller block segments, comprise multiple support fingers arranged next to one another extending in the conveyance direction, in particular conveyor belt fingers, brush support fingers or roller block fingers, wherein, between two adjacent support fingers, a hollow space is present in each case. Here, it is advantageous if the hollow space between two adjacent support fingers is at least as wide as the width of a support finger.

Preferably, all the support fingers of a support segment, in particular conveyor belt fingers of a conveyor belt segment, brush support fingers of a brush support segment or roller block fingers of a roller block segment, are formed identically. This means that the support fingers have the same length measured in the conveyance direction, as well as the same width, measured transversely to the conveyance direction. For example, each conveyor belt finger of a conveyor belt segment preferably has a single circumferential conveyor belt.

Moreover, it is advantageous if the support segments of a support group, in particular conveyor belt segments of a conveyor belt group, brush support segments of a brush support group or roller block segments of a roller block group, are arranged offset transversely with respect to the conveyance direction, so that the support fingers of the two support segments of a support group, in particular conveyor belt fingers of the two conveyor belt segments of a conveyor belt group, brush support fingers of the two brush support segments of a brush support group or roller block fingers of the two roller block segments of a roller block group, partially engage in one another. The two support segments of a support group, in particular conveyor belt segments of a conveyor belt group, brush support segments of a brush support group or roller block segments of a roller block group, are here preferably arranged offset with respect to one another around a support finger, in particular a conveyor belt finger, brush support finger or roller block finger. Due to the offset arrangement, the two support segments can be arranged in a plane, whereby the two support segments are used as support for the semi-finished product to be processed.

Furthermore, in a preferred embodiment, the processing head is movably arranged by means of a positioning system on the guide unit. This applies particularly to rigid guide units which are movable in only one direction of a coordinate system, such as, for example, bridges. On guide units which are movable in all the directions, such as, for example, a robot, the processing head is preferably rigidly arranged, since the guide unit itself is already movable in all the directions. On a guide unit formed as a bridge, multiple processing heads can also be arranged. Collisions between two processing heads arranged on a guide unit can be prevented mechanically or by control technology.

In an advantageous embodiment, multiple processing units are arranged one after the other in the conveyance direction. Preferably, a support group, in particular a conveyor belt group, brush support group or roller block group, of the first processing unit is at the same time a support group, in particular a conveyor belt group, a brush support group or a roller block group, of the second processing unit. Here, the support group which represents a portion of the two processing units has two movable support segments, in particular conveyor belt segments, brush support segments or roller block segments. Alternatively, each processing unit has its own two support groups, in particular conveyor belt groups, brush support groups or roller block groups, wherein the two adjoining support segments, in particular conveyor belt segments, brush support segments or roller block segments, of the two processing units are implemented to be non-movable.

Furthermore, preferably, in the device according to the invention, a passive unit is arranged under the guide unit, in particular under the processing plane. As passive unit, it is possible to use, for example, a collection pan during laser cutting, an anvil or a counterholder during bolt welding, or a counterholder and/or a collection pan in a rotating processing method. Examples of rotating processing methods are countersinking and thread cutting. Alternatively, in rotating processing methods, the active processing unit such as, for example, a drill, can process the semi-finished product to be processed from the bottom upward, starting from the processing plane. In this embodiment, the counterholder would be arranged above the processing plane.

A collection pan is preferably used with all the separation processes. For example, small parts or particles of cutting or welding materials which were separated from the semi-finished product by the process of processing the semi-finished product fall into the collection pan. Moreover, the collection pan represents a counterbearing for the guide unit and/or a weld pool backup.

The device should preferably be used for processing semi-finished products with production systems in which the processing beam and/or energy and/or material spreads under the conveyance plane, such as, for example, in beam systems, in particular laser cutting, laser welding, plasma cutting, plasma welding. The working area of a processing head is provided for example under or above the conveyance plane.

The method according to the invention for transporting and processing semi-finished products by means of an above-described device according to the invention is characterized in that the semi-finished product is processed continuously, in that the working area of the processing head is continuously adjusted during the transporting of the semi-finished product by moving the support segments, in particular conveyor belt segments, brush support segments or roller block segments, in the respective support group, in particular conveyor belt group, brush support group or roller block group.

Preferably, the working area of the processing head is increased or decreased in the conveyance direction. Alternatively, the working area can also remain constant in terms of its size, and, instead, a moving along of the working area with the semi-finished product to be processed on the supports, in particular conveyor belts, brush supports or roller blocks, can be achieved. During the processing, the support segments, in particular conveyor belt segments, brush support segments or roller block segments, can be adjusted in the two directions by means of the setting unit, in order to enable a continuous processing.

For example, the device according to the invention is used for stamping and/or welding and/or cutting and/or forming, such as, for example, flow forming.

Additional details, features, combinations of features, and effects based on the invention result from the following description of preferred exemplary embodiments of the invention as well as from the drawings. The drawings show, in:

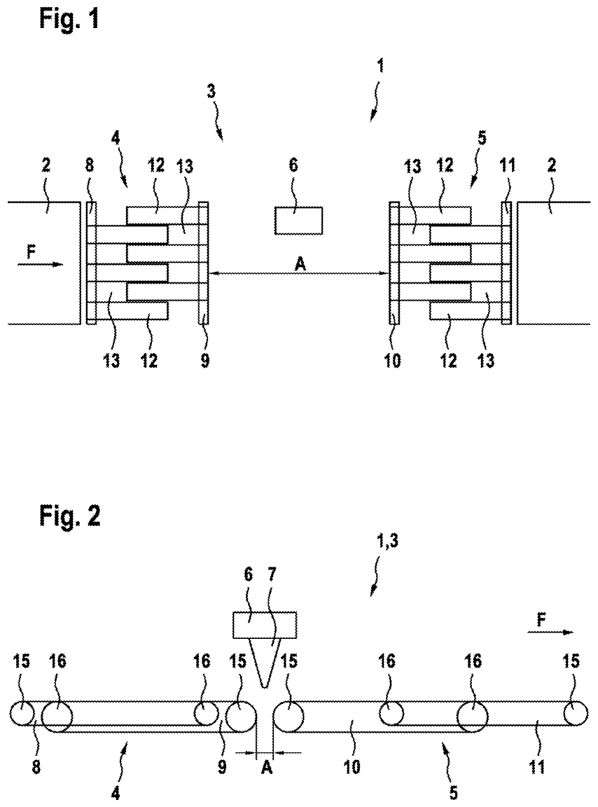

FIG. 1 an exemplary embodiment of a diagrammatically represented device according to the invention in a top view,

FIG. 2 the embodiment from FIG. 1 in a side view,

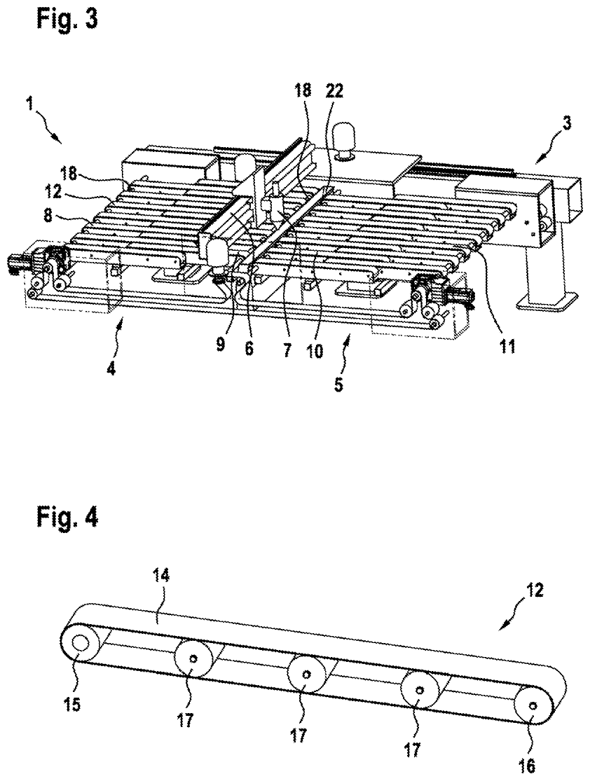

FIG. 3 an exemplary embodiment according to FIG. 1 in a perspective view,

FIG. 4 an exemplary embodiment of a conveyor belt finger in a perspective view,

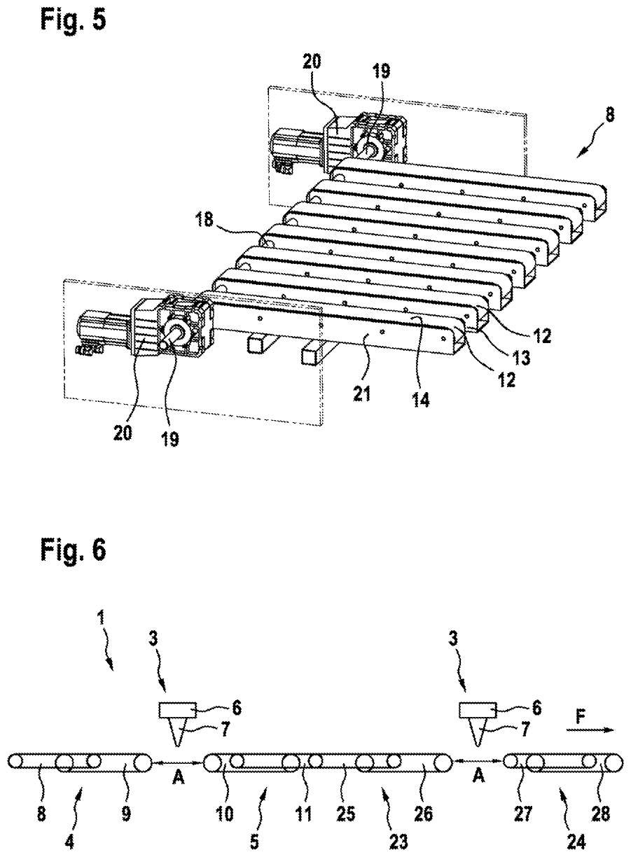

FIG. 5 an exemplary embodiment of a conveyor belt segment with conveyor belt fingers in a perspective view,

FIG. 6 an exemplary additional embodiment of a diagrammatically represented device according to the invention with two processing units in a side view,

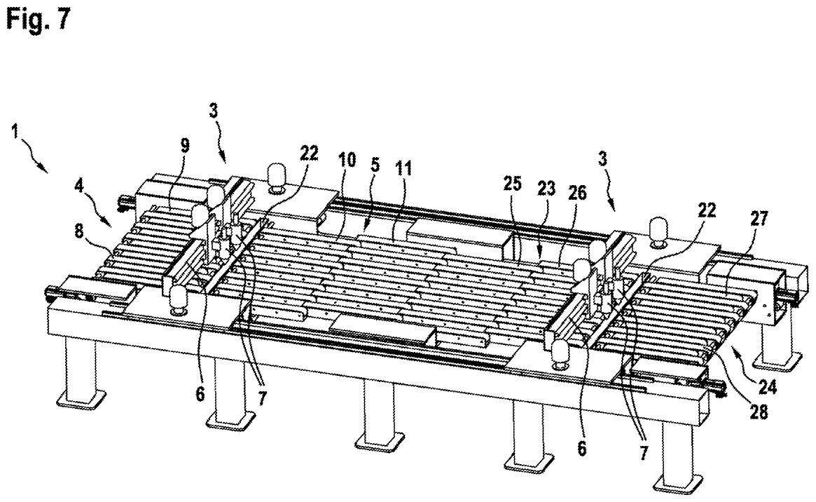

FIG. 7 an exemplary embodiment of a device according to the invention according to FIG. 6 in a perspective view,

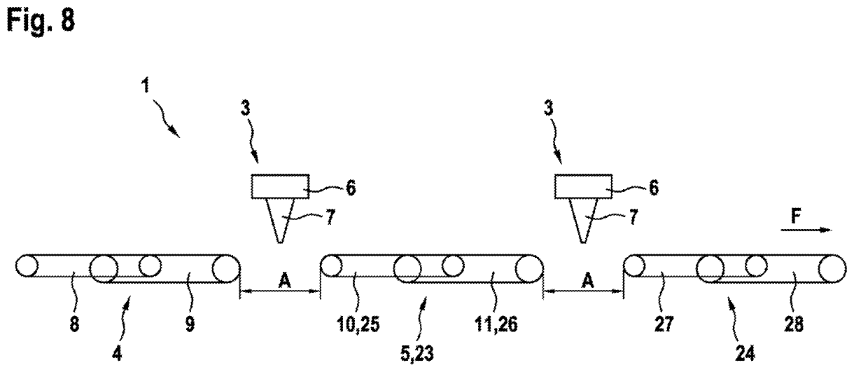

FIG. 8 an additional embodiment of a diagrammatically represented device according to the invention with two processing units in a side view,

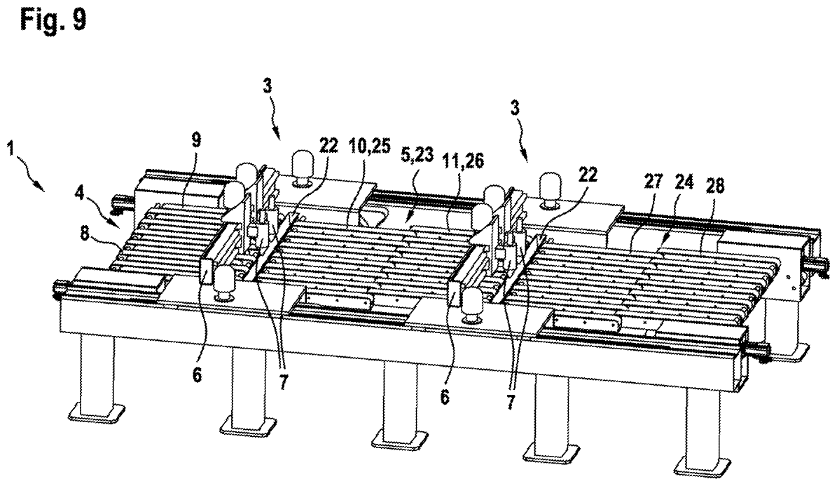

FIG. 9 an exemplary embodiment of a device according to the invention according to FIG. 8 in a perspective view.

Identical or identically operating parts are provided with the same reference numerals in all the figures.

In FIG. 1 and in FIG. 2, an exemplary diagrammatically outlined embodiment of a device 1 according to the invention for transporting and processing semi-finished products is represented in a top view and a side view. In FIG. 3, an exemplary embodiment of the diagrammatically represented device from FIGS. 1 and 2 is shown. The device 1 is arranged between two supports 2 which are formed here as conveyor belts each having the same conveyance direction F. The device 1 according to the invention comprises a processing unit 3 which comprises two support groups 4, 5, a guide unit 6 and a processing head 7. The support groups 4, 5 are formed here as conveyor belt groups. The guide unit 6 is movably arranged in the conveyance direction F between the two support groups 4, 5. On the guide unit 6, the processing head 7 of a manufacturing system, not represented here, is attached, wherein said processing head processes the semi-finished product, also not represented here, resting on the supports 2, here conveyor belts, and the support groups 4, 5, here conveyor belt groups.

Each support group 4, 5 comprises two support segments 8, 9, 10, 11, respectively, which are formed here as conveyor belt segments, wherein each support segment 8, 9, 10, 11 comprises multiple support fingers 12 which are formed as conveyor belt fingers. In FIG. 4, an individual conveyor belt finger 12 is represented, and in FIG. 5 a conveyor belt segment 8 is represented. According to FIGS. 3 and 5, each conveyor belt segment 8, 9, 10, 11 comprises seven conveyor belt fingers 12. The conveyor belt fingers 12 extend in the conveyance direction F of the conveyor belts 2 and are each formed to be of the same length measured in the conveyance direction F. The width of all the conveyor belt fingers 12, measured transversely to the conveyance direction F, is also formed identically. Between two conveyor belt fingers 12, transversely to the conveyance direction F, a hollow space 13 is present, to which at least the width of a conveyor belt finger 12 corresponds.

Each conveyor belt finger 12 comprises a circumferential conveyor belt 14 which is deflected on two deflection rollers 15, 16. Additional rollers 17 are present between the two deflection rollers 15, 16, in order to support the conveyor belt 14 of the conveyor belt finger 12. A deflection roller 15 of the conveyor belt finger 12 has a continuous bore through which a shaft 18 protrudes, wherein the shaft 18 is connected in a torque proof manner to the deflection roller 15, so that, during a rotation of the shaft 18, the rotation is transmitted to the deflection roller 15, whereby the conveyor belt 14 of the conveyor belt finger 12 is set in motion.

On its two ends 19, the shaft 18 is connected to a drive 20 in each case. Alternatively, the use of only one drive 20 with correct dimensioning is also possible.

The conveyor belt finger 12 is moreover surrounded by a cover element 21, so that only the side of the conveyor belt 14 which is used as support for the semi-finished product is uncovered. The rollers 15, 16, 17 and the portion of the conveyor belt 14 lying under the conveyance plane are enclosed by the cover element 21.

According to FIGS. 1 to 3, the conveyor belt segments 8, 9, 10, 11 of each conveyor belt group 4, 5 are offset with respect to one another transversely to the conveyance direction F around a conveyor belt finger 12, so that the conveyor belt finger 12 of the mutually facing conveyor belt segments 8, 9, 10, 11 can engage in one another. For this purpose, the shafts 18 of the mutually correlated conveyor belt segments 8, 9, 10, 11 are provided on the respective ends which are farthest apart from one another. The outer conveyor belt segments 8, 11 of the two conveyor belt groups 4, 5, which adjoin the conveyor belts 2 of the device 1, are stationarily arranged here. The two internal conveyor belt segments 9, 10 of the two conveyor belt groups 4, 5 which face one another in the conveyance direction F, are formed as movable in or against the conveyance direction F.

The space extending between the two movable conveyor belt segments 9, 10 represents the working area A of the processing head 7 of the device 1. The working area A of the processing head 7 is variable due to the movement of the movable conveyor belt segments 9, 10, whereby a continuous processing moving along with the semi-finished product is enabled. The movable conveyor belt segments 9, 10 are moved by means of a setting unit, not represented here.

In FIG. 3, the guide unit 6 is formed as a bridge. The bridge 6 is here arranged so that it can be moved in or against the conveyance direction F on the device 1. The processing head 7 is fastened transversely to the conveyance direction F so that it can be moved on the bridge 6. Under the processing head 7, a passive unit 22, formed here as a collection pan, is formed under the conveyance plane. The collection pan 22 extends over the entire width, measured transversely to the conveyance direction F of the working area A.

In FIG. 6 and FIG. 7, a device 1 according to the invention with two processing units 3 arranged one after the other in the conveyance direction F is represented. In comparison to FIG. 3, two processing units 3 are arranged one after the other in the conveyance direction F. This means that an additional processing unit 3 adjoins the outer support segment 11 of the second support group 5, which also comprises two support groups 23, 24 and a guide unit 6 arranged between the two support groups 23, 24. In the second processing unit 3, the two outermost support segments 25, 28 of the two support groups 23, 24 are also stationarily arranged. The two opposite internal support segments 26, 27 are formed so as to be movable. In contrast to the embodiment from FIG. 3, the guide units 6 formed as bridges each have two processing heads 7. A collision of the two processing heads 7 on a guide unit 6 is prevented by control technology.

In FIGS. 8 and 9, an additional device 1 according to the invention with two processing units 3 arranged one after the other in the conveyance direction F is represented in a side view and in a perspective view. In contrast to the embodiment from FIGS. 6 and 7, the second support group 5 of the first processing unit 3 represents the first support group 23 of the second processing unit 3. Thus, only one support group 5, 23 is present between the two guide units 6 of the two processing units 3. The support segments 10, 11, 25, 26 of the support group 5, 23 are both formed so as to be movable in this embodiment.

The deflection rollers 15, 16 of each conveyor belt segment 8, 9, 10, 11, 25, 26, 27, 28 of a conveyor belt group 4, 5, 23, 24 are represented with different sizes in the diagrammatic FIGS. 2, 6 and 8. This represented size difference is used primarily to distinguish the conveyor belt segments in the drawings. Alternatively, preferably all the deflection rollers 15, 16 of each conveyor belt segment 8, 9, 10, 11 of a conveyor belt group 4, 5 are formed with equal size.

### LIST OF REFERENCE NUMERALS

1 Device
2 Support
3 Processing unit
4 First support group
5 Second support group
6 Guide unit
7 Processing head
8 First support segment of the first support group
9 Second support segment of the first support group
10 First support segment of the second support group
11 Second support segment of the second support group
12 Support finger
13 Hollow space between two support fingers
14 Conveyor belt of a conveyor belt finger
15 First deflection roller of a conveyor belt finger
16 Second deflection roller of a conveyor belt finger
17 Roller
18 Shaft
19 End of the shaft
20 Drive
21 Cover element
22 Passive unit
23 First support group of the second processing unit
24 Second support group of the second processing unit
25 First support segment of the first support group of the second processing unit
26 Second support segment of the first support group of the second processing unit
27 First support segment of the second support group of the second processing unit
28 Second support segment of the second support group of the second processing unit
F Conveyance direction
A Working area of the processing head

1. A device for transporting and processing semi-finished products, comprising: at least one processing unit which comprises two support groups arranged one after the other in a conveyance direction of a semi-finished product, a guide unit and at least one processing head arranged on the guide unit, wherein a working area of the processing head extends between two support groups arranged one after the other over an entire width of the support group, wherein each support group is constructed from two support segments, wherein at least one support segment of a support group is movable, so that the working area of the processing head is variable in the conveyance direction.

2. The device according to claim 1, wherein the support segments comprise multiple support fingers extending next to one another in the conveyance direction, wherein a hollow space is present between each pair of adjacent support fingers.

3. The device according to claim 2, wherein the support segments of a support group are arranged offset transversely with respect to the conveyance direction, so that the support fingers of the two support segments of a support group partially engage one another.

4. The device according to claim 1, wherein the processing head is movably arranged by a positioning system on the guide unit.

5. The device according to claim 1, wherein multiple processing units are arranged one after the other in the conveyance direction.

6. The device according to claim 5, wherein a support group of the first processing unit further comprises a support group of the second processing unit.

7. The device according to claim 6, wherein the support group comprises two movable support segments.

8. The device according to claim 1, wherein a passive unit is arranged under the guide unit.

9. The device according to claim 1, wherein the support groups are formed as conveyor belt groups, wherein each conveyor belt group is constructed from two conveyor belt segments.

10. The device according to claim 9, wherein each conveyor belt segment comprises at least one circumferential conveyor belt.

11. The device according to claim 1, wherein the support groups are formed as brush support groups, wherein each brush support group is constructed from two brush support segments.

12. The device according to claim 1, wherein the support groups are formed as roller block groups, wherein each roller block group is constructed from two roller block segments.

13. A method for transporting and processing semi-finished products by a device according to claim 1, wherein the semi-finished product is processed continuously, by the working area of the processing head being continuously adjusted during transporting of the semi-finished product by moving the support segments in a respective support group.

14. The method according to claim 9, wherein the working area of the processing head is increased or decreased in the conveyance direction.
